(19) United States
(12) Patent Application Publication
(10) Pub. No.: US 2012/0320381 A1
(43) Pub. Date: Dec. 20, 2012

(54) MEASUREMENT APPARATUS AND MEASUREMENT METHOD

(75) Inventor: Yoshiyuki Okada, Sakura-shi (JP)

(73) Assignee: CANON KABUSHIKI KAISHA, Tokyo (JP)

(21) Appl. No.: 13/483,615

(22) Filed: May 30, 2012

(30) Foreign Application Priority Data
Jun. 15, 2011 (JP) 2011-133543

(51) Int. Cl. G01B 9/02

(52) U.S. Cl. 356/484

(57) ABSTRACT

A measurement apparatus obtains a reference signal from light modulated by a first frequency, obtains a measurement signal from light modulated by the first frequency and a second frequency, and measures a position of a target object by calculating a phase difference between the reference signal and the measurement signal. The apparatus includes: a demodulation unit which demodulates the measurement signal by the first frequency; a decimation filter which removes harmonic components from the signal generated by the demodulation unit; a detection unit which detects periodic error components included in the signal output from the decimation filter; a removing unit which removes the periodic error components from the signal output from the decimation filter; and a calculation unit which calculates the position of the target object based on the signal output from the removing unit.

### BACKGROUND OF THE INVENTION

1. Field of the Invention

The present invention relates to a measurement apparatus and a measurement method used to measure a position.

2. Description of the Related Art

In a precise machine working or inspection process, a position or displacement of a target object has to be measured on the precision order of nm to μm, and a length measurement apparatus using the principle of an interferometer is prevalently used. As such a length measurement apparatus, a heterodyne interferometer is used to attain precise length measurements. The heterodyne interferometer detects a reference signal modulated by a frequency fr (an angular frequency ωr=2π×fr) and a measurement signal which is modulated by the frequency fr and includes position information of a target object. Since this measurement signal includes a frequency shift ±fd caused by a Doppler shift according to a moving speed of the target object in addition to a frequency shift of fr due to modulation, its frequency is (fr±fd). By calculating a frequency difference between these reference signal and measurement signal, ±fd is detected. By integrating the frequency difference ±fd by a time, a phase difference is calculated, and a position or displacement of the target object is calculated from the calculated phase difference.

Due to reflection, scattering, and the like by optical members included in the interferometer, periodic length measurement errors occur depending on the Doppler shift. The frequencies of the periodic errors vary depending on the layouts and characteristics of the optical members, and various periodic errors from lower to higher orders like fd/2, −fd, 2fd, 3fd, . . . , may often be included with respect to the frequency shift fd due to the Doppler shift.

Japanese Patent Laid-Open No. 2008-510170 discloses a conventional heterodyne interferometer. The heterodyne interferometer disclosed in Japanese Patent Laid-Open No. 2008-510170 detects a reference signal and measurement signal using an A/D converter of 120 MHz, and makes DFT (Discrete Fourier Transform) computations at intervals of 10 MHz. The heterodyne interferometer further makes CORDIC (Coordinate Rotation Digital Computer) calculations to calculate a phase, thereby measuring a position or displacement.

The heterodyne interferometer further detects periodic errors depending on the Doppler shift from the DFT output, and corrects periodic errors by subtracting the detected errors from the calculated phase. As described in this related art, periodic errors of −fd, 0, 2fd, and 3fd are corrected. As is generally known, the DFT requires a huge calculation volume, and that for N data requires N² complex multiplications and N×(N−1) complex additions. For example, 5184 complex multiplications and 5112 complex additions are required for the DFT of N=72 data. When these calculations are made at intervals of 10 MHz, 5.184×10¹⁰ complex multiplications and 5.112×10¹⁰ complex additions per sec are required. In order to attain such high-speed and large-scale calculations, large-scale parallel computing of ultra-high-speed multiplications and additions are required using a very high-speed DSP (Digital Signal Processor) or FPGA (Field Programmable Gate Array). For this reason, a digital signal processing unit requires high cost, high heat generation, and heavy load calculations.

Periodic errors of the heterodyne interferometer result in a length measurement precision drop, and it is indispensable to reduce periodic errors upon execution of precise length measurements. The frequencies of the periodic errors vary depending on the layouts and characteristics of optical members, and various periodic errors from lower to higher orders like fd/2, −fd, 2fd, 3fd, . . . , may often be included with respect to the frequency shift fd. However, the heterodyne interferometer described in patent literature 1 requires large-scale parallel computing of ultra-high-speed multiplications and additions, the digital signal processing unit requires high cost, high heat generation, and heavy load calculations, resulting in increases in size and cost of the length measurement apparatus.

### SUMMARY OF THE INVENTION

The present invention provides a low-cost measurement apparatus, which precisely measures a position of a target object.

The present invention in its one aspect provides a measurement apparatus, which obtains a reference signal from reference light modulated by a first frequency, obtains a measurement signal from measurement light, which is modulated by a second frequency due to movement of a target object in addition to modulation by the first frequency, and measures a position of the target object by calculating a phase difference between the reference signal and the measurement signal, the apparatus comprising: letting fd be the second frequency, a demodulation unit which generates, by demodulating the measurement signal by the first frequency, a signal including a component of the second frequency, and periodic error components having frequencies n×fd (for n=½, 2, 3, . . . ), and harmonic components of the second frequency; a decimation filter which outputs a signal including the component of the second frequency and the periodic error components by removing the harmonic components from the signal generated by the demodulation unit; a detection unit which detects the periodic error components included in the signal output from the decimation filter; a removing unit which outputs a signal of the component of the second frequency by removing the periodic error components detected by the detection unit from the signal output from the decimation filter; and a calculation unit which calculates the position of the target object based on the signal output from the removing unit.

Further features of the present invention will become apparent from the following description of exemplary embodiments with reference to the attached drawings.

### BRIEF DESCRIPTION OF THE DRAWINGS

FIG. 1 is a block diagram showing the arrangement of a signal processing unit according to the first embodiment;

FIG. 2 is a table showing frequency components of demodulated signals;

FIG. 3 is a block diagram showing the arrangement of a signal generation unit according to the first embodiment;

FIG. 4 is a block diagram showing the arrangement of a signal processing unit according to the second embodiment;

FIG. 5 is a block diagram showing the arrangement of a signal generation unit according to the second embodiment;

FIG. 6 is a block diagram of an amplitude/phase calculator according to the second embodiment;

FIG. 7 is a block diagram showing the arrangement of a signal processing unit according to the third embodiment;

FIG. 8 is a block diagram showing the arrangement of a signal generation unit according to the third embodiment;

FIG. 9 is a block diagram showing the arrangement of a decimation filter;

FIG. 10 is a block diagram showing an example of the arrangement of a PLL;

FIG. 11 is a graph showing an example of the characteristics of a CIC filter; and

FIG. 12 is a block diagram showing an example of the arrangement of a measurement apparatus.

### DESCRIPTION OF THE EMBODIMENTS

A measurement apparatus of the present invention, which obtains a reference signal from reference light modulated by a first frequency, obtains a measurement signal from measurement light, which is modulated by a second frequency due to movement of a target object in addition to modulation by the first frequency, and measures a position of the target object, will be described in detail hereinafter.

### First Embodiment

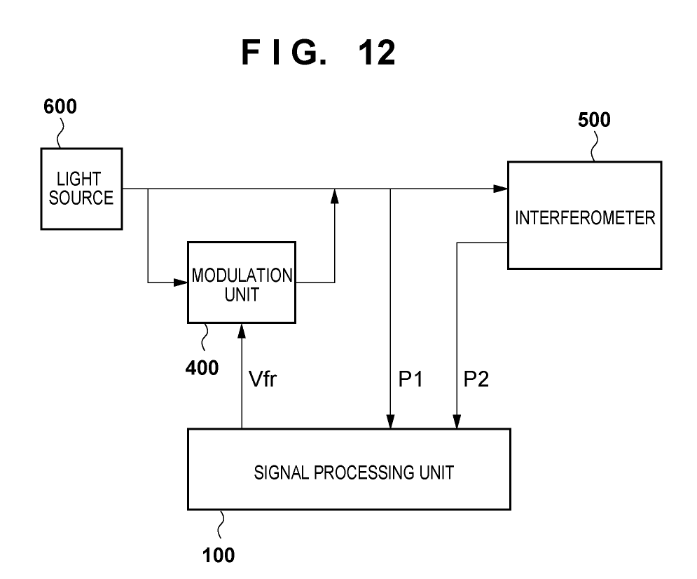

FIG. 12 is a block diagram showing the arrangement of a measurement apparatus according to the present invention, which uses a heterodyne interferometer. A light source 600 is a laser light source, which includes, for example, an HeNe laser having a wavelength of 632.8 nm, or a DFB laser or VCSEL laser as a semiconductor laser having a wavelength of 640 to 2880 nm. A modulation unit 400, which modules light, includes an AOM (Acousto-Optic Modulator) or the like. By driving the modulation unit 400 by a signal Vfr based on:

Vfr=Va×sin(2π×fr×t) (1)

from a signal processing unit 100, laser beams output from the modulation unit 400 are modulated by a first frequency fr (a first angular frequency ωr=2πfr).

One of the laser beams modulated by the first frequency fr enters the signal processing unit 100 as reference light P1. A target object included in an interferometer 500 is irradiated with the other of the laser beams modulated by the first frequency fr, and reflected light from the target object enters the signal processing unit 100 as measurement light P2. The measurement light P2 is modulated by a second frequency fd (a second angular frequency ωd=2πfd) due to a Doppler shift caused by movement of the target object in addition modulation by the first frequency. The reference light P1 and measurement light P2 are respectively given by:

P1=(A/2)×{sin(2π×fr×t+θr)+1} (2)

P2=(B/2)×[sin {2π×(fr+fd)×t+θd}+1] (3)

where A is a reference light intensity, B is a measurement light intensity, fr is the first frequency, fd is the second frequency, θr is a fixed phase of the reference light, and θd is a fixed phase of the measurement light.

The modulation by the second frequency fd is that generated according to a moving speed of the target object, and is described by:

fd=j×v/λ (4)

where v is the moving speed of the target object, λ is the wavelength of the light source, and j is an order decided by the configuration of the interferometer.

The modulation by the second frequency due to the Doppler shift has a polarity of +fd or −fd according to the moving direction of the target object. For example, when the light source having λ=1.55 μm is used, and v=1 m/s and j=4, fd=2.58 MHz.

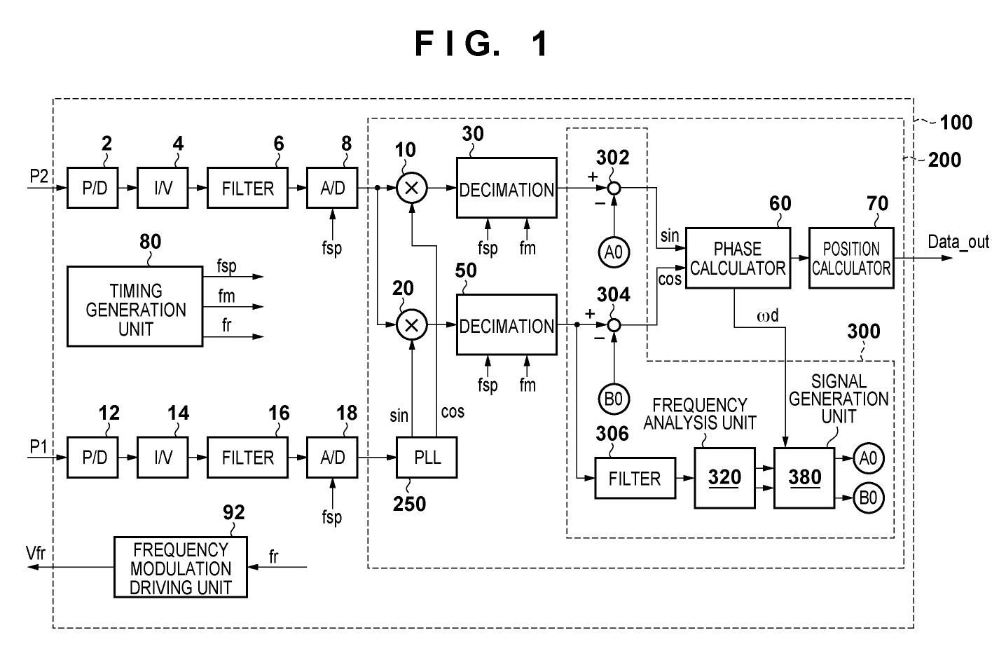

FIG. 1 shows the arrangement of the signal processing unit 100 of the first embodiment. The reference light P1 and measurement light P2 are respectively converted into currents by first and second photodiodes 2 and 12. As the first and second photodiodes 2 and 12, for example, PIN photodiodes, avalanche photodiodes, or the like are used. The outputs from the first and second photodiodes 2 and 12 are input to first and second I/V converters 4 and 14 and are converted into voltages, respectively. The first and second I/V converters 4 and 14 include, for example, resistors and OP amplifiers. The outputs from the first and second I/V converters 4 and 14 are respectively input to first and second filters 6 and 16. The first and second filters may be LPFs (Low Pass Filters) which limit high-frequency ranges or BPFs (Band Pass Filters) which cut DC components and limit high-frequency ranges since the reference light P1 and measurement light P2 are AC signals. In this case, in order to cut DC components and to detect only sine terms as AC signals, equations (2) and (3) are modified like:

P1′=(A/2)×sin(2π×fr×t+θr) (5)

P2′=(B/2)×sin {2π×(fr+fd)×t+θd} (6)

The outputs from the first and second filters 6 and 16 are respectively input to first and second A/D converters 8 and 18, and are sampled at a sampling frequency fsp to be converted into a digital reference signal and digital measurement signal. The digital signals obtained in this way are input to a digital signal processor 200. The digital signal processor 200 includes, for example, an FPGA, ASIC, DSP, or the like, which can process the digital signals at high speed. “ASIC” is a short for “Application Specific Integrated Circuit”.

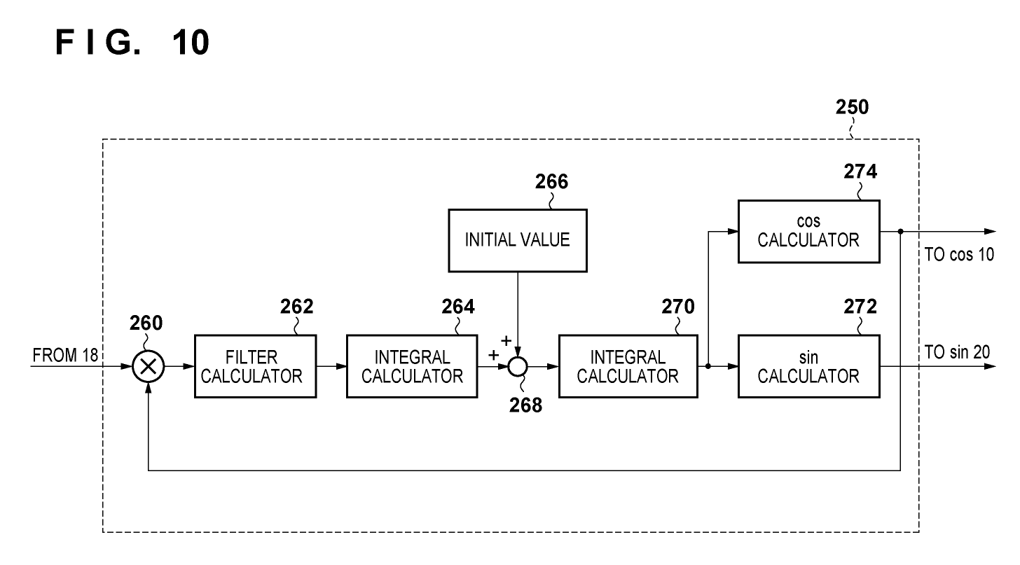

The digital reference signal is input to a PLL (Phase Locked Loop) 250 which synchronizes a phase. The operation of the PLL 250 will be described below with reference to FIG. 10. The digital reference signal is input to a phase comparator 260. The phase comparator 260 includes, for example, a multiplier. The output from the phase comparator 260 is input to a filter calculator 262 to remove harmonic components from the phase comparator 260. The output from the filter calculator 262 is input to an integral calculator 264.

An integral calculation by this integral calculator 264 is made for the purpose of integral control required to set an output deviation of the phase comparator 260 to be zero, and the integral calculator 264 may be configured to execute stable control as proportional-integral control. The output from the integral calculator 264 is input to an adder 268, and is added to an initial value 266. As the initial value 266, that corresponding to the first frequency modulation fr is set. An integral calculator 270 and sine calculator 272, and the integral calculator 270 and a cosine calculator 274 are sine and cosine signal generation units corresponding to VCOs (Voltage Controlled Oscillators). The operations of these calculators are described by:

Sine signal=sin {∫(Vᵢ+Vₒ)dt} (7)

Cosine signal=cos {∫(Vᵢ+Vₒ)dt} (8)

where Vᵢ is the output from the integral calculator 264, and Vₒ is the output of the initial value 266.

The sine calculator 272 and cosine calculator 274 may generate sine and cosine signals by, for example, saving sine and cosine values, which are calculated in advance, in a memory as a table, and looking up the table according to the values in { } of equations (7) and (8). A memory size required when an amplitude range of the sine signal is 12 bits and a time resolution is 10 bits (×1024) is 12 bits×1024=12.288 kbits. A memory size required when an amplitude range of the sine signal is 16 bits and a time resolution is 12 bits (×4096) is 16 bits×4096=65.536 kbits. These memory sizes can be easily realized by using an internal memory of the FPGA, ASIC, DSP, or the like. Since the calculations of the PLL 250 can be implemented by several multipliers and adders, the calculation load on digital signal processing can be reduced very much.

The output from the cosine calculator 274 is fed back to the phase comparator 260, and the sine and cosine signals are generated so that the aforementioned integral calculator 264 sets the output deviation of the phase comparator 260 to be zero. Since the output deviation becomes zero, the frequencies and phases of the digital reference signal and an output P1_sin of the sine calculator 272, which is given by equation (7), are perfectly synchronized. Also, an output P1_cos of the cosine calculator 274, which is given by equation (8), becomes a synchronization signal having a 90° phase difference. The outputs P1_sin and P1_cos are respectively given by:

P1_sin=Vb×sin(2π×fr×t+θr) (9)

P1_cos=Vb×cos(2π×fr×t+θr) (10)

where Vb is an amplitude.

Referring back to FIG. 1, the description of the digital signal processor 200 will be continued. First and second synchronous detectors 10 and 20 multiply the digital measurement signal P2′ by the sign signal P1_sin and cosine signal P1_cos, which are synchronized with the digital reference signal generated by the PLL 250. The first and second synchronous detectors 10 and 20 include, for example, multipliers.

From equations (6), (9), and (10), the outputs from the first and second synchronous detectors 10 and 20 are respectively described by:

Output from First Synchronous Detector 10

P2′×P1_cos=(B/2)×sin {2π×(fr+fd)×t+θd}×Vb×cos(2π×fr×t+θr)=(B×Vb/4)×[sin(2π×fd×t+θd−θr)+sin {2π×(2fr+fd)×t+θd+θr}] (11)

Output from Second Synchronous Detector 20

P2′×P1_sin=(B/2)×sin {2π×(fr+fd)×t+θd}×Vb×sin(2×fr×t+θr)=(B×Vb/4)×[cos(2π×fd×t+θd−θr)−cos {2π×(2fr+fd)×t+θd+θr}] (12)

The first terms of the right-hand sides of final expressions of equations (11) and (12) are cosine and sine parts of components of the second frequency as the frequency fd generated according to the moving speed of the target object. The second terms of the right-hand sides of the final expressions of equations (11) and (12) include harmonic components of a frequency (2fr+fd) generated by the first and second synchronous detectors 10 and 20. The first and second synchronous detectors 10 and 20 configure a demodulation unit which generates signals that include the components of the second frequency, periodic error components having frequencies n×fd (for n=½, 2, 3, . . . ) and harmonic components, by demodulating the measurement signal by the first frequency.

The outputs from the first and second synchronous detectors 10 and 20 are respectively input to first and second decimation filters 30 and 50. The first and second decimation filters 30 and 50 filter the inputs by a decimation frequency to attenuate a harmonic component of a frequency (2fr+fd) generated by the first and second synchronous detectors 10 and 20, so as to reduce the calculation load on the digital signal processing.

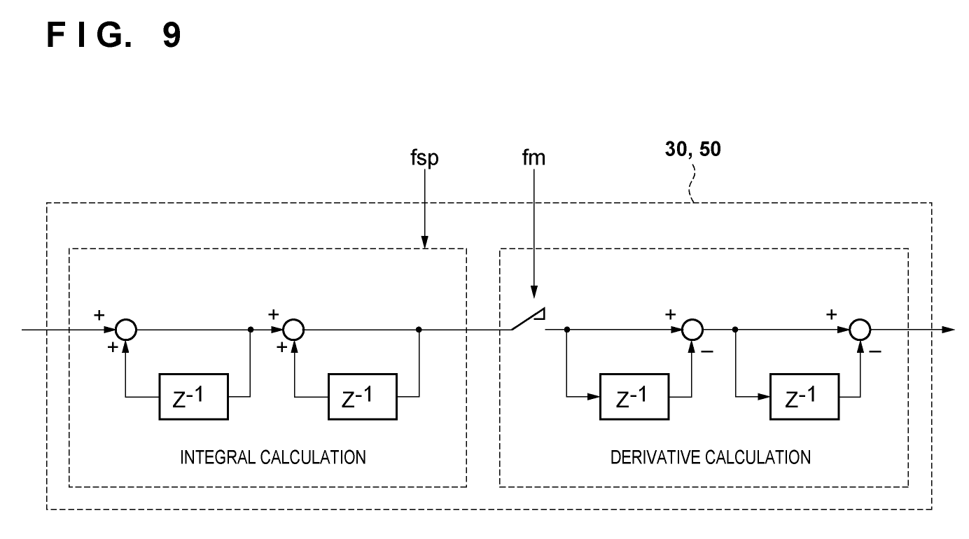

The operations of the first and second decimation filters 30 and 50 will be described below with reference to FIG. 9. The first and second decimation filters 30 and 50 may be CIC (Cascaded Integrator-Comb) filters each of which includes an integral calculation operated at the sampling frequency fsp and a derivative calculation operated at a decimation frequency fm. In this case, a transfer function of each of the first and second decimation filters is given by:

|H(f)|=|{sin(π×D×f/fsp)/sin(π×f/fsp/m)}^{N}| (13)

where H(f) is a transfer function of the decimation filter, D is a delay difference (1 or 2), m is a decimation ratio (an integer not less than 2), and N is the number of integrator and differentiator stages.

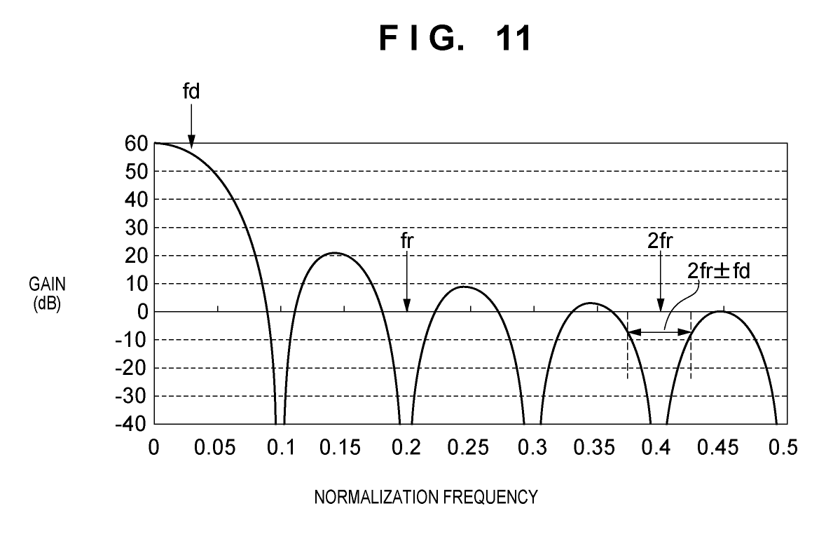

FIG. 9 shows the arrangement of the CIC filter when N=2. FIG. 11 shows an example of the characteristics of the CIC filter when D=2, m=5, and N=3. Although fsp=100 MHz, since a signal frequency which can undergo digital signal processing in this case is 50 MHz, the abscissa plots ratios of the sampling frequency=100 MHz to signal frequencies, which are to undergo digital signal processing in practice, as normalization frequencies. Since m=5, the decimation frequency fm=20 MHz, and a signal frequency which undergoes digital signal processing is 10 MHz as ½ of the decimation frequency. For this reason, in FIG. 11, at the normalization frequency=0.1, that is, 10 MHz, notch characteristics appear, that is, a gain attenuates abruptly.

FIG. 11 shows a case of fr=20 MHz and fd=2.58 MHz. A frequency of a harmonic component generated by the first and second synchronous detectors 10 and 20 is (2fr+fd)=40±2.58 MHz, and can be efficiently removed by the notch characteristics of the CIC filters. The first and second decimation filters 30 and 50 configure a decimation filter, which removes the harmonic component from signals generated by the demodulation unit, and outputs signals including components of the second frequency and periodic error components.

Referring back to FIG. 1, the description of the digital signal processor 200 will be continued. The outputs from the first and second decimation filters 30 and 50 are input to a phase calculator 60, and the output from the phase calculator 60 is input to a position calculator 70. The phase calculator 60 makes, using the signals from the first and second decimation filters 30 and 50, an arctangent calculation given by:

Phase angle=tan⁻¹[B×Vb/4×sin(2π×fd×t+θd−θr)/{B×Vb/4×cos(2π×fd×t+θd−θr)}]=tan⁻¹{sin(2π×fd×t+θd−θr)/cos(2π×fd×t+θd−θr)} (14)

Equation (14) yields a phase difference between the digital reference signal and digital measurement signal. The position calculator 70 converts the phase difference from the phase calculator 60 into a position or displacement. For example, from equation (4), a position or displacement L of the target object is described by:

L=(λ/j)×∫(fd)dt={(λ/j)/(2π)}×θ (15)

where θ is a phase angle.

From equation (15), a position coefficient (λ/j) is (λ/j)=387.5 nm when λ=1.55 μm and j=4. This represents that the phase angle output θ=2π corresponds to a position or displacement of L=387.5 nm. A temporal differentiation of the phase angle given by equation (14) or that of the position or displacement given by equation (15) exhibits a value according to the frequency shift fd caused by a Doppler shift according to the moving speed of the target object.

The second angular frequency cod corresponding to the second frequency fr is given by:

ωd=2π×fd (16)

FIG. 1 shows an example in which the phase calculator 60 calculates ωd, and outputs it to a signal generation unit 380. Alternatively, the position calculator 70 may calculate ωd, as described above. Note that timing frequencies fsp, fm, and fr to the first and second A/D converters 8 and 18, the first and second decimation filters 30 and 50, and a frequency modulation driving unit 92 are generated by a timing generation unit 80. The phase calculator 60 and position calculator 70 configure a calculation unit which calculates a position of the target object based on the signal output from a removing unit. Also, the phase calculator 60 and position calculator 70 configure the calculation unit which calculates a provisional value of a change amount of a phase difference between the reference signal and measurement signal or that of a position of the target object from the signals output from the decimation filters, and calculates a provisional value of the second frequency from the calculated provisional value of the change amount.

On measurement light from the interferometer, error signals, which are periodic with respect to the second frequency fd depending on the Doppler shift (periodic error components), are often superposed due to reflection, scattering, and incompleteness of optical members included in the interferometer. The frequencies of periodic error components vary depending on the layouts and characteristics of the optical members, and may often include, for example, various frequencies from lower to higher orders like fd/2, 2fd, 3fd, . . . . The periodic error components cause length measurement errors in the output from the position calculator 70. A periodic error component detection/removing unit 300 detects unwanted error signals nωd (n=½, 2, 3, . . . ) included in a demodulated signal obtained by demodulation by the first angular frequency ωr(=2π×fr). FIG. 1 shows an example in this the output from the second decimation filter 50 is used in detection of the error signals nωd. Alternatively, the output from the first decimation filter 30 may be used.

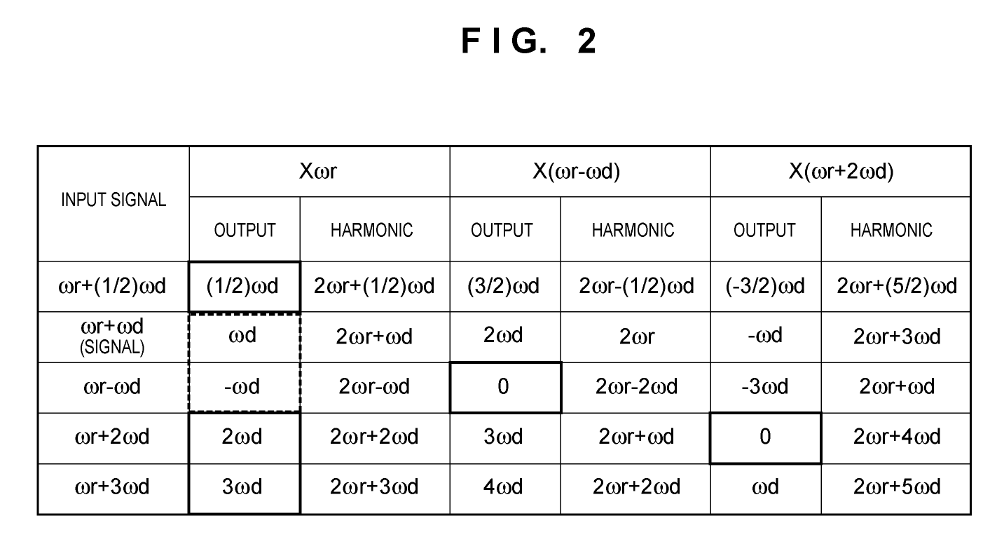

FIG. 2 shows input signals (ωr+nωd; n=½, 1, −1, 2, and 3), and outputs and harmonic components as demodulated signals for signals (×ωr, ×(ωr−ωd), and ×(×r+2ωd)) used in demodulation. In the first embodiment, demodulation is done using the first angular frequency ωr. Unwanted error signals included in the demodulated signal in this case are (½)ωd, 2ωd, and 3ωd bounded by bold solid lines in the left column. At this time, the output of the demodulated signal for the input signal (ωr+ωd) is ωd, and the output of the demodulated signal for (ωr−ωd) is −ωd. For this reason, since the two demodulated signals have the same frequency and are synthesized, they cannot be separately detected. On the other hand, harmonic components have frequencies as high as (2ωr+nωd), and are removed by the first or second decimation filter 30 or 50.

The output signal from the second decimation filter 50 may be further filtered by a filter 306 as needed, or may be decimated and filtered by another decimation filter. A frequency analysis unit 320 is a calculator which computes Fourier transforms. The frequency analysis unit 320 may compute FFTs (Fast Fourier Transforms), so as to reduce the calculation load. The FFTs include calculations of complex additions and complex multiplications, and letting N be the number of samples, the numbers of calculations are respectively given by:

Complex addition=N×log₂N (17)

Complex multiplication=N/2×log₂N (18)

The sampling frequency fsp and a frequency resolution Δf of the FFTs have a relationship given by:

Δf=fsp/N (19)

In this embodiment, the measurement signal is demodulated by the first angular frequency or to generate a demodulated signal, which is input to the decimation filters 30 and 50 to calculate amplitudes and phases of unwanted signals. For this reason, the first angular frequency component of ωr is removed, and signal detection calculations can be made at an angular frequency sufficiently lower than the angular frequency ωr. For example, assume that the sampling frequency fsp is 100 MHz, the decimation frequency fm by the decimation filter 50 after demodulation by ωr is 20 MHz, and a decimation frequency fm2 by the filter 306 is 10 MHz. When the number N of samples is 128, the FFT computations of the frequency analysis unit 320 include 896 complex additions and 448 complex multiplications, and a frequency resolution Δf is 78.13 kHz. For example, when a light source of λ=1.55 μm is used, and j=4, periodic error components of angular frequencies nωd (n=½, 2, 3, . . . ) included in modulated signals at fd=78.13 kHz to 5 MHz, that is, a speed v=0.03 to 1.94 m/s can be detected. Note that when these calculations are made at intervals of 78.13 kHz, 7.00×10⁷ complex additions and 3.5×10⁷ complex multiplications are required per second. A high-speed calculator such as the FPAG can execute additions and multiplications at cycles of 100 MHz (10⁸) or more, and can easily execute the aforementioned calculations with a very light calculation load.

As described above, in the first embodiment, the detection/removing unit 300 demodulates the measurement signal by the first angular frequency ωr, inputs the demodulated signal to the decimation filter, and then detects periodic error components of the angular frequencies nωd (n=½, 2, 3, . . . ) by computing Fourier transforms such as FFTs. For this reason, the angular frequency component of or is removed, and calculations required to detect periodic frequency components can be made at an angular frequencies sufficiently lower than the angular frequency ωr. Therefore, in the heterodyne interferometer which detects the position or displacement of the target object, various periodic error components from lower to higher orders with respect to the Doppler shift are corrected while reducing the calculation load on the digital signal processing, thereby precisely measuring the position or displacement with low cost. The frequency analysis unit 320 calculates and outputs amplitudes and phases of periodic error components nωd (n=½, 2, 3, . . . ). The signal generation unit 380 generates signals AO and B0 required to remove the periodic error components included in the measurement signal based on these amplitudes and phases.

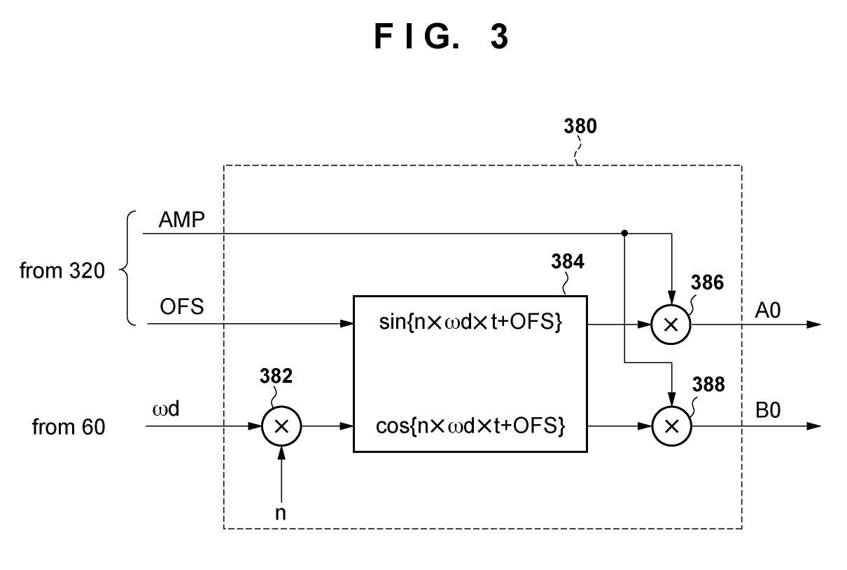

The operation of the signal generation unit 380 will be described below with reference to FIG. 3. From the frequency analysis unit 320, an amplitude AMP and phase OFS of each periodic error component nωd (n=½, 2, 3, . . . ) are input. Also, from the phase calculator 60 (or position calculator 70), the provisional value of ωd is input. The provisional value of ωd is multiplied by an order n (n=½, 2, 3, . . . ) of an unwanted error signal by a multiplier 382 to output nωd. A sine/cosine generation unit 384 calculates (nωd×t+OFS), and outputs sine and cosine signals based on this value. In this case, t is a time.

The sine and cosine signals may be generated by, for example, saving sine and cosine values, which are calculated in advance, in a memory as a table, and by looking up the table according to the (nωd×t+OFS) value. A memory size required when an amplitude range is 10 bits and a time resolution is 10 bits (×1024) is 10 bits×1024=10.24 kbits. The sine and cosine signals from the sine/cosine generation unit 384 are multiplied by the amplitude AMP by multipliers 386 and 388. Then, output signals from the signal generation unit 380 have an amplitude and phase, which match those of the periodic error component nωd (n=½, 2, 3, . . . ).

The output signals AO and B0 from the multipliers 386 and 388, that is, removing signals, are input to adders/subtractors 302 and 304, thus removing unwanted periodic error components included in the measurement signals from the first and second decimation filters 30 and 50. The signal generation unit 380 may generate only a signal of n=½ or a plurality of signals of n=½, 2, and 3 for the orders n (n=½, 2, 3, . . . ) of periodic error components included in the measurement signal. These periodic error components are generated due to reflection, scattering, and incompleteness of optical members included in the interferometer, and vary depending on the layouts and characteristics of the optical members. Hence, signals to be generated may be decided according to the design and component characteristics. When a plurality of periodic error components are to be removed, a plurality of signal generation units 380 may be arranged to generate a plurality of removing signals, which are added by the adders/subtractors 302 and 304, thereby removing unwanted periodic error components included in the measurement signal.

The filter 306, frequency analysis unit 320, and signal generation unit 380 of the first embodiment configure a detection unit which detects periodic error components included in signals output from the decimation filters 30 and 50. The adders/subtractors 302 and 304 configure a removing unit which removes the periodic error components detected by the detection unit from the signals output from the decimation filters 30 and 50, and outputs signals of components of the second frequency.

Therefore, according to the present invention, the measurement signal is demodulated by the first angular frequency ωr, the decimation filters 30 and 50 remove harmonic components and lower a processing speed of the subsequent digital signal processing, thereby detecting and removing periodic error components. Thus, the calculation load on the digital signal processing unit required to detect periodic error components can be reduced very much, thus allowing to configure a low-cost measurement apparatus, which removes various periodic error components from lower to higher orders with respect to a Doppler shift, and precisely measures a position or displacement.

### Second Embodiment

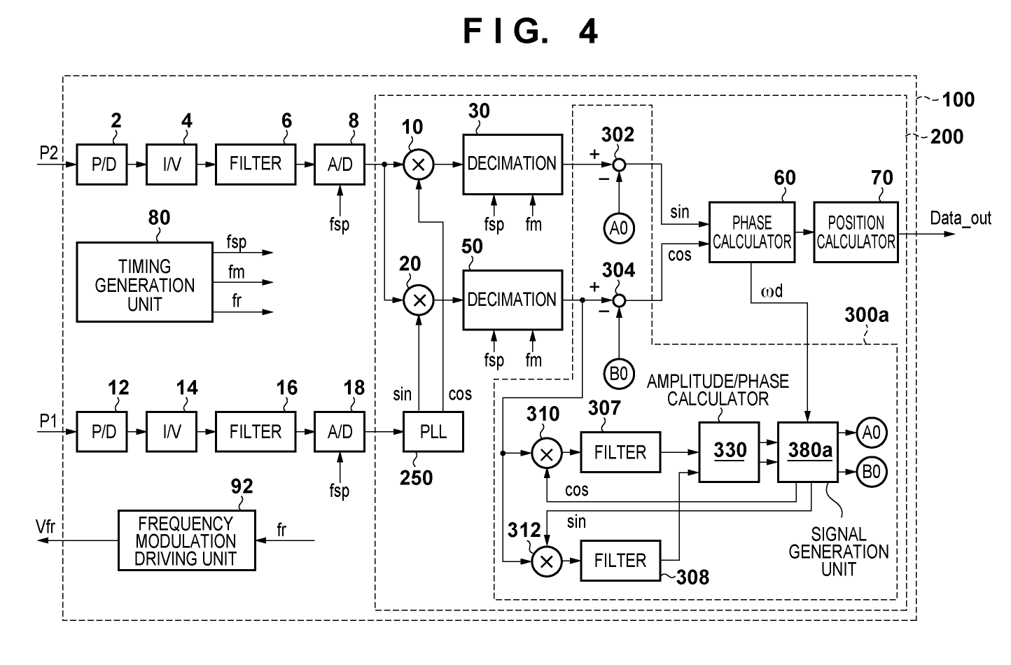

The second embodiment will be described below with reference to FIG. 4. The same reference numerals denote components which perform the same operations as in the first embodiment, and a description thereof will not be repeated. A component different from the first embodiment is a detection/removing unit 300a. In order to calculate amplitudes and phases of periodic error components included in a measurement signal, the detection/removing unit 300a, which detects and removes periodic error components according to the second embodiment, includes third and fourth synchronous detectors 310 and 312 in place of the frequency analysis unit 320 which computes Fourier transforms and is used in the first embodiment. By further multiplying a demodulated signal obtained by demodulating the measurement signal by an angular frequency ωr by cosine or sine signals of periodic error components having frequencies nωd (n=½, 2, 3, . . . ), the third and fourth synchronous detectors 310 and 312 attain demodulations.

Referring to FIG. 2, periodic error components included in demodulated signals when a signal used in demodulation for input signals (ωr+nωd; n=½, 1, −1, 2, and 3) is ωr are (½)ωd, 2ωd, and 3ωd bounded by the bold solid lines in the left column. At this time, an output of the demodulated signal for an input signal (ωr+ωd) is ωd, and an output of the demodulated signal for (ωr−ωd) is −ωd. For this reason, since these outputs have the same frequency, and are synthesized, they cannot be separately detected. On the other hand, harmonic components have frequencies as high as (2ωr+nωd), and are removed by the first or second decimation filter 30 or 50. The signal generation unit 380a generates cosine and sine signals of periodic error components having frequencies nod (n=½, 2, 3, . . . ), which signals are to be input to the third and fourth synchronous detectors 310 and 312.

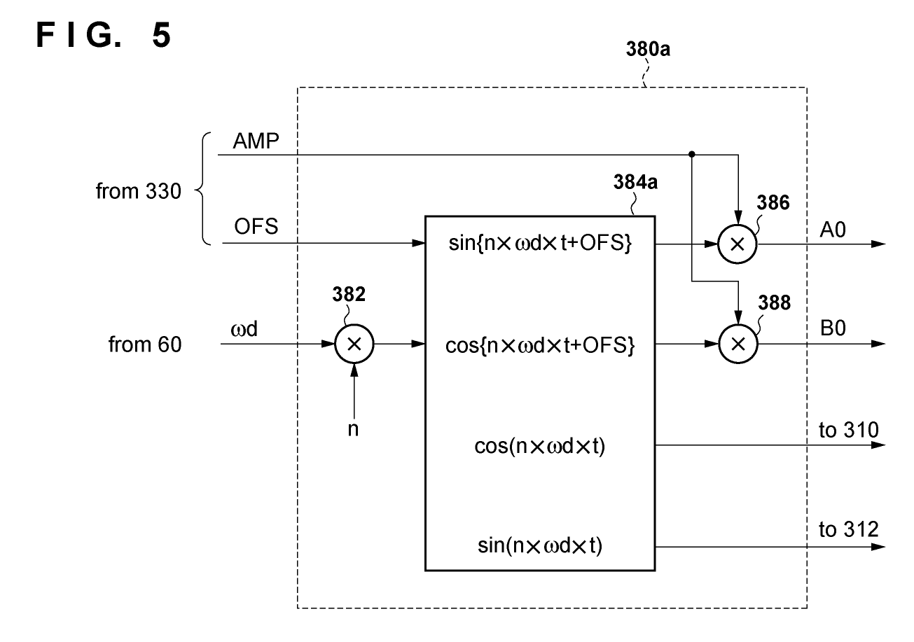

FIG. 5 is a block diagram showing the arrangement of the signal generation unit 380a. The phase calculator 60 inputs ωd. As described in the first embodiment, the position calculator 70 may calculate ωd. A multiplier 382 multiplies ωd by orders n (n=½, 2, 3, . . . ) of periodic error components to output nod. A sine/cosine generation unit 384a calculates nωt×t, thus outputting sine and cosine signals based on these values. In this case, t is a time. The sine and cosine signals may be generated by, for example, saving sine and cosine values, which are calculated in advance, in a memory as a table, and looking up the table according the values (nωd×t).

A memory size required when an amplitude range is 10 bits and a time resolution is 10 bits (×1024) is 10 bits×1024=10.24 kbits. Cosine and sine signals from the sine/cosine generation unit 384a are input to the third and fourth synchronous detectors 310 and 312, and are used to demodulate the output signal from the second decimation filter 50. Note that in FIG. 4, the signal from the second decimation filter 50 is demodulated by the third and fourth synchronous detectors 310 and 312. Alternatively, the signal from the first decimation filter 30 may be demodulated.

The outputs from the third and fourth synchronous detectors 310 and 312 are input to filters 307 and 308. The filters 307 and 308 may be LPFs (Low Pass Filters) or decimation filters using CIC filters or the like. Signals from the filters 307 and 308 are input to an amplitude/phase calculator 330.

The second synchronous detector 20 removes the first frequency ωr as a frequency modulated component, and the output from the second decimation filter 50 includes ωd and frequency error components nωd (n=½, 2, 3, . . . ). The third and fourth synchronous detectors 310 and 312 generate demodulated signals based on cos(2π×n×fd×t) and sin(2π×n×fd×t) as signals from the signal generation unit 380a. The demodulated signals are respectively given by:

Vn×cos(2π×n×fd×t+θn)×cos(2π×n×fd×t)=Vn/2×{cos(θn)+cos(4π×n×fd×t+θn)} (20)

Vn×cos(2π×n×fd×t+θn)×sin(2π×n×fd×t)=Vn/2×{−sin(θn)+sin(4π×n×fd×t+θn)} (21)

where Vn indicates amplitudes of periodic error components from the second decimation filter 50, and θn indicates phases of periodic error components from the second decimation filter 50.

The second terms of the right-handed sides of equations (20) and (21) are harmonic components, which are removed by the filters 307 and 308. Therefore, the output signals of the filters 307 and 308 are respectively described by:

Output of filter 307=Vn/2×cos(θn) (22)

Output of filter 308=−Vn/2×sin(θn) (23)

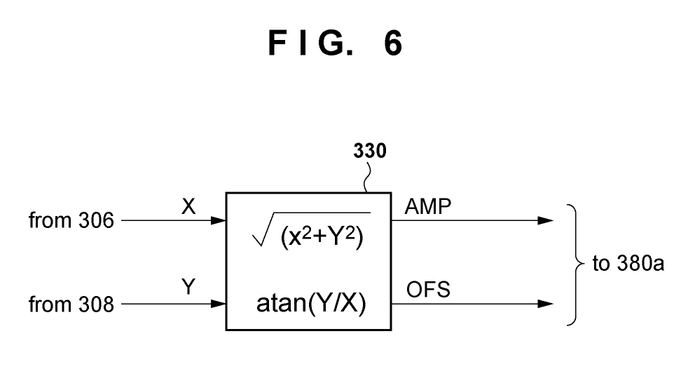

The amplitude/phase calculator 330 applies calculations shown in FIG. 6 to the input signals given by equations (22) and (23). That is, the calculator 330 makes calculations given by:

Amplitude AMP=√[{Vn/2×cos(θn)}²+{−Vn/2×sin(θn)}²]×√2=Vn (24)

Phase OFS=a tan [{−Vn/2×sin(θn)}/{Vn/2×cos(θn)}]×(−1)=a tan {sin(θn)/cos(θn)} (25)

As a result, the amplitudes Vn and phases θn of periodic error components nωd (n=½, 2, 3, . . . ) can be calculated. A method of generating removing signals required to remove periodic error components included in the measurement signal based on these amplitudes and phases is the same as that in the first embodiment. For example, a case will be examined below wherein periodic error components included in demodulated signals are to be detected when a light source of λ=1.55 μm is used, j=4, fd=78.13 kHz to 5 MHz, that is, a speed v=0.03 to 1.94 m/s, and fr=20 MHz. Assume that the sampling frequency fsp=100 MHz, and a decimation frequency fm=20 MHz by the second decimation filter 50 after demodulation by ωr. The outputs of the third and fourth synchronous detectors 310 and 312 are described by the phases θn of periodic error components of the first terms and harmonic components (4π×n×fd×t+θn) of the second terms of the right-handed sides of equations (20) and (21). The amplitudes Vn and phases θn to be detected are expressed by DC signals, and the filters 307 and 308 remove harmonic components.

For example, when n=½, harmonic components are expressed by 2×n×fd=78.13 kHz to 5 MHz. Also, as signal amplitudes in the input signals shown in FIG. 2 and the demodulated signals by ×ωr, a ωd component generated by (ωr+ωd) as a measurement signal and ωr has the largest amplitude. Upon demodulation by (½)ωd, (½)ωd=39.07 kHz as a difference between them appears in the demodulated signal. A case will be examined below wherein the filters 307 and 308 use decimation filters, as shown in FIG. 11. If a decimation frequency fm2=100 kHz, (½)ωd=39.07 kHz (around a normalization frequency=0.4) to be removed with respect to the amplitudes Vn and phases θn (DC signals) to be detected has a removing ratio of −60 dB or less. Hence, a sufficient removing ratio can be obtained.

As described above, according to the second embodiment, a measurement signal is demodulated by the angular frequency ωr to generate a demodulated signal, and the decimation filters 30 and 50 remove harmonic components and lower a processing speed of the subsequent digital signal processing. Furthermore, the apparatus of the second embodiment has the third and fourth synchronous detectors 310 and 312 which demodulate the demodulated signals using sine and cosine signals having frequencies nωd (n=½, 2, 3, . . . ) and the filters (or decimation filters) 307 and 308 for the signals from the synchronous detectors. Thus, the amplitudes and phases of periodic error signals to be detected are converted into DC signals, and the filters 307 and 308 remove harmonic components and lower a processing speed of the digital signal processing, thereby detecting and removing periodic error components. In the second embodiment, frequency components of periodic error components nωd (n=½, 2, 3, . . . ) are generated based on ωd calculated by the phase calculator 60 or position calculator 70. For this reason, even when the target object moves to have a larger acceleration, and the ωd value changes largely, precise signals of periodic error components nωd can be generated, and periodic error components can be detected more precisely, thus allowing to configure a high-precision interferometer.

Orders n of periodic error components which can be detected and removed by the detection/removing unit 300a of the second embodiment and are included in the measurement signal are n=½, 2, 3, . . . For example, only a signal of n=½ or a plurality of signals of n=½, 2, and 3 may be removed. These error signals are generated due to reflection, scattering, and incompleteness of optical members included in the interferometer, and frequencies of periodic error components vary depending on the layouts and characteristics of the optical members. Hence, periodic error components to be generated may be decided according to the design and component characteristics. When a plurality of periodic error components are to be removed, a plurality of sets of the third and fourth synchronous detectors, filters, amplitude/phase calculators, and signal generation units are arranged to generate a plurality of removing signals, and these removing signals are added by the adders/subtractors 302 and 304, thus removing periodic error components included in the measurement signal.

Note that the second embodiment uses, in detection of periodic error components, the third and fourth synchronous detectors 310 and 312 and the filters (or decimation filters) 307 and 308 for the signals from these synchronous detectors in place of the FFT of the first embodiment. Assume that the decimation frequency fm of the second decimation filter 50 is set to be fm=20 MHz. Both the third and fourth synchronous detectors 310 and 312 require 2×10⁷ multiplications, which are equal to the number of calculations of the filters (or decimation filters) 307 ad 308. A high-speed calculator such as the FPAG can execute additions and multiplications at cycles of 100 MHz (10⁸) or higher, and can easily execute the aforementioned calculations with a very light calculation load. Therefore, according to the second embodiment, various periodic error components from lower to higher orders with respect to a Doppler shift can be detected and removed, and a position or displacement can be precisely measured with low cost, while reducing a calculation load on the digital signal processing. Even when the target object moves to have a larger acceleration, periodic error components nωd (n=½, 2, 3, . . . ) can be precisely detected, thus allowing to configure an interferometer with higher precision.

### Third Embodiment

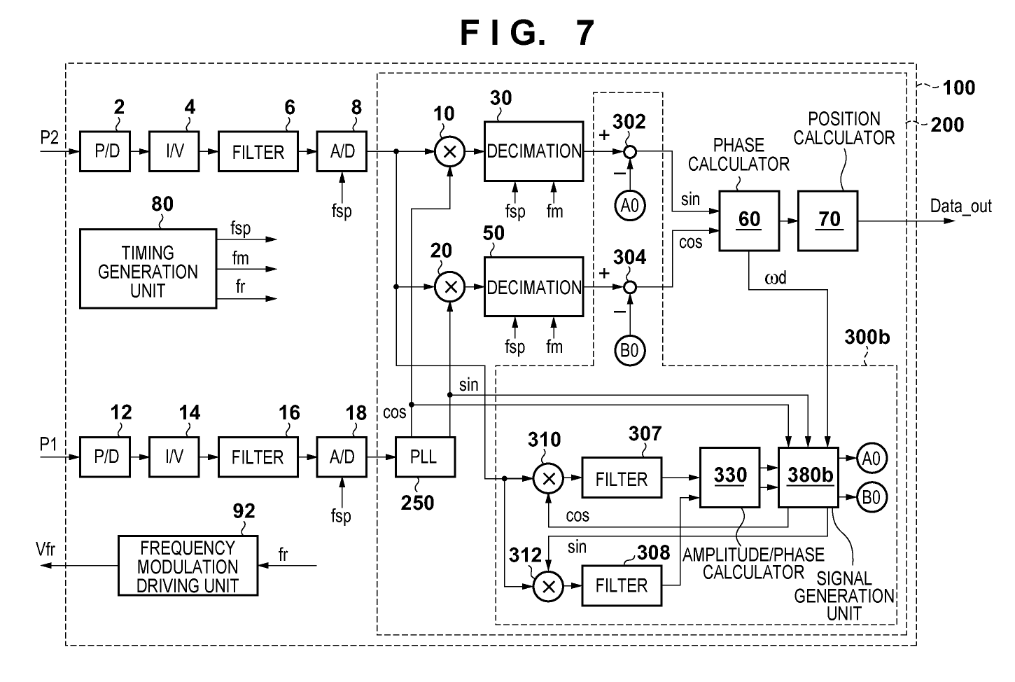

The third embodiment will be described below with reference to FIG. 7. The same reference numerals denote components which perform the same operations as those in the first and second embodiments, and a description thereof will not be repeated. A component different from the first embodiment is a detection/removing unit 300b which detects and removes periodic error components. A difference between the third embodiment and the first and second embodiments lies in that an amplitude and phase of a periodic error component of −ωd included in a measurement signal can be detected. Note that in the third embodiment, periodic error components of nωd (n=½, 2, 3, . . . ) can be detected as in the first and second embodiments.

Periodic error components included in the measurement signal are generated due to reflection, scattering, and incompleteness of optical members included in an interferometer, and frequencies of the periodic error components vary depending on the layouts and characteristics of the optical members. The first and second embodiments have exemplified the case in which one or a plurality of orders n (n=½, 2, 3, . . . ) of periodic error components nωd are detected. However, depending on the layouts and characteristics of the optical members, a case of n=−1 may occur. As shown in FIG. 2, when a signal (×ωd) is used in demodulation of input signals (ωr+nωd; n=½, 1, −1, 2, and 3), an output of a demodulated signal for the input signal (ωr+ωd) is ωd, and an output of the demodulated signal for (ωr−ωd) is −ωd. For this reason, since these outputs have the same frequency and are synthesized, they cannot be separately detected.

Thus, as shown in FIG. 7, in order to calculate amplitudes and phases of periodic error components included in a measurement signal, an output of the A/D converter 8 of the measurement signal is input to the third and fourth synchronous detectors 310 and 312, and demodulation is executed using a modulated component and sine and cosine signals of a frequency (ωr−ωd). In this case, in the demodulated signals, “0” bounded by the bold solid line of the central output ×(ωr−ωd) in FIG. 2, that is, a DC signal is a signal component of a periodic error component −ωd. Other periodic error components nωd (n=½, 2, 3, . . . ) are (3/2)ωd, 2ωd, 3ωd, and 4ωd, that is, harmonic components of ωd.

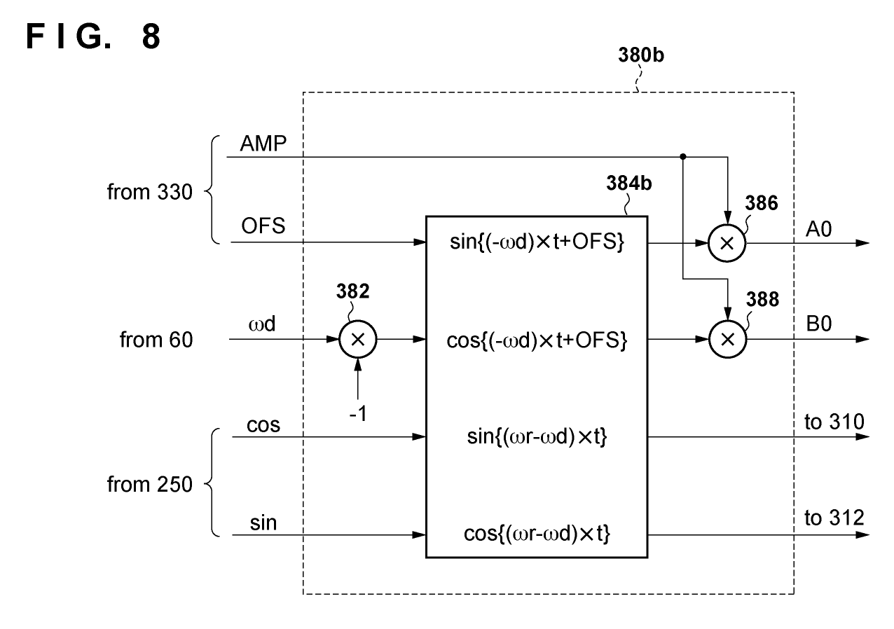

FIG. 8 is a block diagram showing the arrangement of a signal generation unit 380b. The phase calculator 60 inputs ωd. As described in the first embodiment, the position calculator 70 may calculate ωd. The multiplier 382 multiplies ωd by an order n=−1 to output (−ωd). On the other hand, sine and cosine signals synchronized with the reference signal from the PLL 250 are input, and a sine/cosine generation unit 384b calculates (ωr−ωd)×t, thus outputting sine and cosine signals based on this value. In this case, t is a time. Note that the signal from the PLL 250 may be an angular frequency signal ωr synchronized with the reference signal.

The sine and cosine signals may be generated by, for example, saving sine and cosine values, which are calculated in advance, in a memory as a table, and looking up the table according to the value (ωr−ωd)×t. A memory size required when an amplitude range is 10 bits and a time resolution is 10 bits (×1024) is 10 bits×1024=10.24 kbits. The cosine and sine signals from the sine/cosine generation unit 384b are input to the third and fourth synchronous detectors 310 and 312, and are used to demodulate the output signal from the A/D converter 8 of the measurement signal.

The outputs of the third and fourth synchronous detectors 310 and 312 are input to the filters 307 and 308. The filters 307 and 308 may be LPFs (Low Pass Filters) or decimation filters using CIC filters or the like. Signals from the filters 307 and 308 are input to the amplitude/phase calculator 330. The sine/cosine generation unit 384b calculates (−ωd)×t+OFS using a phase OFS signal from the amplitude/phase calculator 330, and sine and cosine signals based on this value are output. Other arrangements and operations are the same as those in the first and second embodiments.

Demodulated signals from the third and fourth synchronous detectors 310 and 312 generate, based on cos {2π×(fr−fd)×t} and sin {2π×(fr−fd)×t} as signals from the signal generation unit 380b, signals described by:

Vn×cos {2π×(fr−fd)×t+θn}×cos {2π×(fr−fd)×t}=Vn/2×{cos(θn)+cos(4π×(fr−fd)×t+θn)} (26)

Vn×cos {2π×(fr−fd)×t+θn}×sin {2π×(fr−fd)×t}=Vn/2×{−sin(θn)+sin(4π×(fr−fd)×t+θn)} (27)

where Vn indicates amplitudes of periodic error components from the decimation filters and θn indicate phases of periodic error components from the decimation filters.

The second terms of the right-handed sides of equations (26) and (27) are harmonic components, which are removed by the filters 307 and 308. The first terms of the right-handed sides indicate a component of a periodic error component −ωd to be detected, and an amplitude and phase are detected as DC signals. Therefore, the output signals of the filters 307 and 308 are respectively expressed by equations (22) and (23) described in the second embodiment.

The detection method of the amplitude and phase of the periodic error component −ωd included in the measurement signal has been described as the third embodiment. As in the first and second embodiments, periodic error components of nωd (n=½, 2, 3, . . . ) can be detected. The right side of FIG. 2 shows frequency components for demodulated signals when an input signal ×(ωr+2ωd) is used. In this case, “0” bounded by the bold solid line, that is, a DC signal is a periodic error component +2ωd to be detected. Other periodic error components nωd (n=½, 1, −1, 3, . . . ) are (−3/2)ωd, −ωd, −3ωd, and ωd, that is, harmonic components of ωd. These harmonic components are removed by the filters 307 and 308.

A difference between the third embodiment and the second embodiment lies in the operation frequencies of the third and fourth synchronous detectors 310 and 312 which generate demodulated signals by demodulating the measurement signal by sine and cosine signals having frequency components of angular frequencies (ωr+nωd) (n=½, −1, 2, 3, . . . ). For example, the third and fourth synchronous detectors 310 and 312 multiply the measurement signal and (ωr−ωd) at the sampling frequency fsp=100 MHz. The decimation frequency of the subsequent filters 307 and 308 is the same as that in the second embodiment, and the amplitude/phase calculator 330 can be configured to have, for example, fm2=100 kHz. Therefore, in the third embodiment, calculations required to detect periodic error components can be made at a frequency sufficiently lower than a modulation frequency ωr. For example, when the frequency of the third and fourth synchronous detectors 310 and 312 is set to be fsp=100 MHz, these detectors respectively require 10⁸ multiplications. After the filters (or decimation filters) 307 and 308, if the decimation frequency is set to be, for example, fm2=100 kHz, the number of calculations is greatly reduced. A high-speed calculator such as the FPAG can execute additions and multiplications at cycles of 100 MHz (10⁸) or more, and can easily execute the aforementioned calculations with a very light calculation load.

As described above, according to the third embodiment, the measurement signal is demodulated by sine and cosine signals having frequency components of angular frequencies (ωr+nωd) (n=½, −1, 2, 3, . . . ) to generate demodulated signals, and a frequency component ωr and harmonic components are removed by the filters 307 and 308. Thus, the amplitude and phase of a periodic error component to be detected are DC signals, and a processing speed of the digital signal processing is lowered with respect to the frequency ωr, thus detecting and removing the periodic frequency component. A component of an error signal −ωd is generated based on ωd calculated by the phase calculator 60 or position calculator 70. For this reason, even when the target object moves to have a larger acceleration and the value ωd changes largely, precise signals nωd can be generated, and error signals can be detected more precisely, thus allowing to configure a high-precision interferometer.

Therefore, according to the third embodiment, various periodic error components from lower to higher orders with respect to a Doppler shift can be detected and removed, and a position or displacement can be precisely measured with low cost, while reducing a calculation load on the digital signal processing. Also, even when the target object moves to have a larger acceleration, periodic error components nωd (n=½, 2, 3, . . . ) can be accurately detected, thus allowing to configure an interferometer with higher precision.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-133543 filed Jun. 15, 2011, which is hereby incorporated by reference herein in its entirety.

What is claimed is:

1. A measurement apparatus, which obtains a reference signal from reference light modulated by a first frequency, obtains a measurement signal from measurement light, which is modulated by a second frequency due to movement of a target object in addition to modulation by the first frequency, and measures a position of the target object by calculating a phase difference between the reference signal and the measurement signal, said apparatus comprising:
letting fd be the second frequency,
a demodulation unit which generates, by demodulating the measurement signal by the first frequency, a signal including a component of the second frequency, and periodic error components having frequencies n×fd (for n=½, 2, 3, . . . ), and harmonic components of the second frequency;
a decimation filter which outputs a signal including the component of the second frequency and the periodic error components by removing the harmonic components from the signal generated by said demodulation unit;
a detection unit which detects the periodic error components included in the signal output from said decimation filter;
a removing unit which outputs a signal of the component of the second frequency by removing the periodic error components detected by said detection unit from the signal output from said decimation filter; and
a calculation unit which calculates the position of the target object based on the signal output from said removing unit.

2. The apparatus according to claim 1, wherein said detection unit calculates amplitudes and phases of the periodic error components by computing Fourier transforms of the signal output from said decimation filter, and generates the signals of the periodic error components to be removed by said removing unit using the calculated amplitudes and phases, and
said removing unit removes the periodic error components using the signals generated by said detection unit.

3. The apparatus according to claim 1, wherein said detection unit demodulates the signal output from said decimation filter by frequencies of the periodic error components, removes harmonic components from the demodulated signals, calculates amplitudes and phases of the periodic error components from the signals from which the harmonic components are removed, and generates signals of the periodic error components to be removed by said removing unit using the calculated amplitudes and phases, and
said removing unit removes the periodic error components using the signals generated by said detection unit.

4. The apparatus according to claim 3, wherein said calculation unit calculates a provisional value of a change amount of a phase difference between the reference signal and the measurement signal or a change amount of a position of the target object from the signal output from said decimation filter, and calculates a provisional value of the second frequency from the calculated provisional value of the change amount, and
said detection unit generates signals of frequencies of the periodic error components using the provisional value of the second frequency calculated by said calculation unit, and demodulates the signal output from said decimation filter using the generated signals.

5. A measurement apparatus, which obtains a reference signal from reference light modulated by a first frequency, obtains a measurement signal from measurement light, which is modulated by a second frequency due to movement of a target object in addition to modulation by the first frequency, and measures a position of the target object by calculating a phase difference between the reference signal and the measurement signal, said apparatus comprising:
letting fr be the first frequency and fd be the second frequency, and n=½, −1, 2, 3, . . .
a demodulation unit which generates, by demodulating the measurement signal by the first frequency, a signal including a component of the second frequency, and periodic error components having frequencies n×fd, and harmonic components of the second frequency;
a decimation filter which outputs a signal including the component of the second frequency and the periodic error components by removing the harmonic components from the signal generated by said demodulation unit;
a detection unit which detects the periodic error components by demodulating the measurement signal by frequencies (fr+n×fd);
a removing unit which outputs a signal of the component of the second frequency by removing the periodic error components detected by said detection unit from the signal output from said decimation filter; and
a calculation unit which calculates the position of the target object based on the signal output from said removing unit.

6. The apparatus according to claim 5, wherein said detection unit demodulates the measurement signal by the frequencies (fr+n×fd), removes the harmonic components from the demodulated signals, calculates amplitudes and phases of the periodic error components from the signals from which the harmonic components are removed, and generates signals of periodic error components to be removed by said removing unit using the calculated amplitudes and phases, and
said removing unit removes the periodic error components using the signals generated by said detection unit.

7. The apparatus according to claim 6, wherein said calculation unit calculates a provisional value of a change amount of a phase difference between the reference signal and the measurement signal or a change amount of a position of the target object from the signal output from said decimation filter, and calculates a provisional value of the second frequency from the calculated provisional value of the change amount, and
said detection unit generates signals of the frequencies (fr+n×fd) using the provisional value of the second frequency calculated by said calculation unit, and demodulates the measurement signal using the generated signals.

8. The apparatus according to claim 1, further comprising a phase synchronization unit which generates a signal of the first frequency used in demodulation by said demodulation unit from the reference signal.

9. The apparatus according to claim 1, wherein said decimation filter is a Cascaded Integrator Comb filter.

10. The apparatus according to claim 5, further comprising a phase synchronization unit which generates a signal of the first frequency used in demodulation by said demodulation unit from the reference signal.

11. The apparatus according to claim 5, wherein said decimation filter is a Cascaded Integrator Comb filter.

12. The apparatus according to claim 1, wherein the apparatus is a heterodyne interferometer.

13. The apparatus according to claim 5, wherein the apparatus is a heterodyne interferometer.

14. A method of measuring a position of a target object by obtaining a reference signal from reference light modulated by a first frequency, obtaining a measurement signal from measurement light, which is modulated by a second frequency due to movement of a target object in addition to modulation by the first frequency, and calculating a phase difference between the reference signal and the measurement signal, said method comprising:
letting fd be the second frequency,
a demodulation step of generating, by demodulating the measurement signal by the first frequency, a signal including a component of the second frequency, and periodic error components having frequencies n×fd (for n=½, 2, 3, . . . ), and harmonic components of the second frequency;
a decimation step of outputting a signal including the component of the second frequency and the periodic error components by removing the harmonic components from the signal generated in the demodulation step;
a detection step of detecting the periodic error components included in the signal output in the decimation step;
a removing step of outputting a signal of the component of the second frequency by removing the periodic error components detected in the detection step from the signal output in the decimation step; and
a calculation step of calculating the position of the target object based on the signal output in the removing step.

15. A method of measuring a position of a target object by obtaining a reference signal from reference light modulated by a first frequency, obtaining a measurement signal from measurement light, which is modulated by a second frequency due to movement of a target object in addition to modulation by the first frequency, and calculating a phase difference between the reference signal and the measurement signal, said method comprising:
letting fr be the first frequency and fd be the second frequency, and n=½, −1, 2, 3, . . .
a demodulation step of generating, by demodulating the measurement signal by the first frequency, a signal including a component of the second frequency, and periodic error components having frequencies n×fd, and harmonic components of the second frequency;
a decimation step of outputting a signal including the component of the second frequency and the periodic error components by removing the harmonic components from the signal generated in the demodulation step;
a detection step of detecting the periodic error components by demodulating the measurement signal by frequencies (fr+n×fd);
a removing step of outputting a signal of the component of the second frequency by removing the periodic error components detected in the detection step from the signal output in the decimation step; and
a calculation step of calculating the position of the target object based on the signal output in the removing step.
